(19) United States
(12) Patent Application Publication
(10) Pub. No.: US 2009/0024467 A1
(43) Pub. Date: Jan. 22, 2009

(54) Serving Advertisements with a Webpage Based on a Referrer Address of the Webpage

(76) Inventors: Marcus Felipe Fontoura, Los Gatos, CA (US); Andrei Zary Broder, Menlo Park, CA (US); Vanja Josifovski, Los Gatos, CA (US)

Correspondence Address: STATTLER - SUH PC, 60 SOUTH MARKET STREET, SUITE 480, SAN JOSE, CA, 95113, US

(21) Appl. No.: 11/781,140

(22) Filed: Jul. 20, 2007

(51) Int. Cl. G06Q 30/00

(52) U.S. Cl. 705/14

(57) ABSTRACT

Methods for selecting advertisements to serve to a client requesting a primary webpage is provided. The client displays a referring webpage having a hyperlink to the primary webpage. Upon selection of the hyperlink, the client sends a request to a content server storing the primary webpage, the request including a referrer of the primary webpage comprising a URL address of the referring webpage. The content server sends the primary webpage to the client which includes the referrer and an advertisement request mechanism configured to make an advertisement request to an advertisement server and attach the referrer to the advertisement request. The advertisement server uses the referrer to select one or more advertisements to serve to the client. The referrer may comprise one or more search query terms submitted by the client. The advertisement server may also use the content of the primary webpage to select the one or more advertisements.

### FIELD OF THE INVENTION

The present invention is directed towards serving advertisements with a webpage based, on a referrer address of the webpage.

### BACKGROUND OF THE INVENTION

When a user makes a request for a webpage (base content) to a server via a network, additional content is also typically sent to the user along with the base content. The user can be a human user interacting with a user interface of a computer that transmits the request for base content. Base content might include a variety of content and is typically provided and presented to a user as a published webpage. For example, base content presented as a webpage may include published information, such as articles about politics, business, sports, movies, weather, finance, health, consumer goods, etc. Additional content might include content that is relevant/related to the base content. For example, relevant additional content may include advertisements for products or services that are related to the base content.

Base content providers receive revenue from advertisers who wish to have their advertisements displayed to users and typically pay a particular amount each time a user clicks on one of their advertisements. A variety of methods may be employed to determine which additional content to display to a user. The need for determining which advertisements to serve to a user is important in improving the user experience of a webpage and in maximizing advertiser revenue.

Typically, the text content of a webpage is used to determine which advertisements to display to the user along with the requested webpage. Often, however, the text content of a webpage may produce advertisements that are not of interest to the user. As such, there is a need for an improved method for determining advertisements to serve to a user requesting a webpage.

### SUMMARY OF THE INVENTION

A method and apparatus for selecting advertisements to serve to a user/client system requesting a webpage is provided. A client system (operated by a user) may display, e.g., via a web browser program, an initial webpage (referred to as the referring webpage) that shows one or more hyperlinks to one or more landing webpages. Upon selection of one of the hyperlinks (referred to as the primary hyperlink) by the user, the client system sends a request (e.g., a hypertext transfer protocol (HTTP) request) to a base content server that stores and maintains the selected landing webpage (referred to as the primary webpage) of the selected hyperlink. Typically, the client system (e.g., via the web browser program) includes a “referrer” of the primary webpage (e.g., an uniform resource locator (URL) address of the prior referring webpage from which the primary webpage was retrieved) in the request for the primary webpage sent to the base content server.

Upon receiving the request for the primary webpage (the request including the referrer of the primary webpage), the base content server retrieves and sends the primary webpage to the client system, the primary webpage comprising base content requested by the user. In some embodiments, the primary webpage also includes data regarding the referrer of the primary webpage (e.g., attached to the metadata field of the primary webpage). In further embodiments, the primary webpage further includes an embedded advertisement request mechanism (e.g., iframe mechanism, JavaScript code, etc.) configured to make an advertisement request (e.g., HTTP request) to an additional content server (that stores a plurality of advertisements) to send one or more advertisements to serve with the primary webpage. In some embodiments, the embedded advertisement request mechanism is configured to read the data regarding the referrer of the primary webpage (e.g., read the referrer data from the metadata field of the primary webpage) and include the referrer data in the advertisement request to the additional content server. In other embodiments, the embedded advertisement request mechanism is configured to extract one or more terms from the referrer data and include the one or more extracted terms in the advertisement request to the additional content server. The advertisement request mechanism embedded in the primary webpage may be configured to perform these operations, for example, upon the primary webpage being received and displayed by the client system.

After receiving the advertisement request that includes referrer data of the primary webpage and/or terms extracted from the referrer data, the additional content server uses the referrer data to select one or more advertisements to serve with the primary webpage. As such, data regarding the referrer of a primary webpage (e.g., an URL address of the prior referring webpage from which the primary webpage was retrieved) is used to select one or more advertisements to serve with the primary webpage. In some embodiments, the content of the primary webpage is also used to select the one or more advertisements to serve with the primary webpage. The additional content server then sends the one or more selected advertisements to the client system for display to the user.

In some embodiments, a user/client system may submit a search query to a search engine server. In these embodiments, the client system may display an initial webpage (referred to as the query entry webpage) and receive, from the user, a search query comprising one or more terms (e.g., via a user interface). The client system may submit the search query to a search engine server (e.g., via a network) that, in response, returns a search results webpage (referred to as the referring webpage) showing search results (e.g., in the form of one or more hyperlinks to one or more landing webpages). When creating the search results webpage, the search engine server typically attaches the search query terms to the uniform resource locator (URL) address of the search results webpage. As known in the art, a search query submitted by a user and attached to a URL address of a search results webpage is sometimes referred to as a referral string (since it is this particular search, query that refers the user to a particular landing webpage selected, by the user and is used to retrieve the particular landing webpage).

The client system then receives, from the user, a selection of one of the hyperlinks (referred to as the primary hyperlink) in the search results. Upon receiving the selection the primary hyperlink, the client system sends a request (e.g., HTTP request) to a base content server that stores and maintains the selected landing webpage (the primary webpage) of the selected hyperlink. Typically, the client system includes a referrer of the primary webpage (e.g., an URL address of the prior referring webpage from which the primary webpage was retrieved) in the request for the primary webpage sent to the base content server. Since the search query is attached to the URL address of the search results webpage (which is the prior referring webpage) by the search engine server, the referrer will contain the terms of the search query and be included in the request for the primary webpage sent to the base content server.

Upon receiving the request for the primary webpage (the request including the referrer of the primary webpage and hence includes the search query), the base content server retrieves and sends the primary webpage to the client system, the primary webpage comprising base content requested by the user. In some embodiments, the primary webpage also includes data regarding the referrer of the primary webpage (and hence includes data regarding the search query terms). The primary webpage may further include an embedded advertisement request mechanism configured to make an advertisement request to an additional content server to send one or more advertisements to serve with the primary webpage. In some embodiments, the embedded advertisement request mechanism is configured to read the data regarding the referrer of the primary webpage (and hence to read data regarding the search query) and include the referrer data (and hence include search query data) in the advertisement request to the additional content server. In other embodiments, the embedded advertisement request mechanism is configured to extract one or more terms from the referrer data (and hence to extract one or more terms from the search query) and include the one or more extracted terms in the advertisement request to the additional content server.

After receiving the advertisement request that includes referrer data (and hence search query data) of the primary webpage and/or terms extracted from the referrer data, the additional content server uses the referrer data to select one or more advertisements to serve with the primary webpage. As such, data regarding the referrer of a primary webpage (and hence data regarding the search query) is used to select one or more advertisements to serve with the primary webpage. In some embodiments, the content of the primary webpage is also used to select the one or more advertisements to serve with the primary webpage. The additional content server then sends the one or more selected advertisements to the client system for display to the user.

By selecting advertisements to serve with a webpage using information derived from a referrer address of the webpage, an additional resource of information may be used to select the advertisements. The referrer address of the webpage contains useful information in selecting advertisements for a user since it provides information regarding a just prior website that the user visited. In the particular condition, where a search query is also submitted by a user, the referrer address of the webpage may contain especially useful information since the search query reflects the intent of the user. By considering the referrer address of the webpage, the rate of selections/clicks on advertisements by users may increase and advertisement revenue may be optimized.

### BRIEF DESCRIPTION OF THE DRAWINGS

The novel features of the invention are set forth in the appended claims, However, for purpose of explanation, several embodiments of the invention are set forth in the following figures.

FIG. 1 shows a network environment in which some embodiments operate.

FIG. 2 shows a conceptual diagram of a revenue-optimization system.

FIG. 3 is a block diagram of an exemplary interface for displaying base content and additional content according to some embodiments;

FIG. 4A shows an exemplary referring webpage;

FIG. 48 shows an exemplary primary webpage having a metadata section;

FIG. 5A shows an exemplary search query entry webpage having a search query interface;

FIG. 5B shows an exemplary referring webpage having a URL address containing attached search query terms:

FIG. 5C shows an exemplary primary webpage having a metadata section;

FIGS. 6A-B are flowcharts of a method for selecting one or more advertisements to serve to a client system requesting a webpage;

FIGS. 7A-B are flowcharts, of a method for selecting one or more advertisements to serve to a client system performing a search query and requesting a webpage;

FIG. 8 shows a conceptual diagram of the operation of the advertisement selection module in selecting advertisements to serve; and

FIG. 9 shows a conceptual diagram of an alternative embodiment of the advertisement selection module in selecting advertisements to serve.

### DETAILED DESCRIPTION

In the following description, numerous details are set forth for purpose of explanation. However, one of ordinary skill in the art will realize that the invention may be practiced without the use of these specific details. In other instances, well-known structures and devices are shown in block diagram form in order not to obscure the description of the invention with unnecessary detail.

As described below, Section I discusses general terms and a network environment in which some embodiments operate. Section II discusses methods and apparatus for selecting advertisements to serve to a user requesting a webpage using a referrer address of the webpage.

### Section I: General Terms and Network Environment

As used herein, base content is requested by a user that may include a variety of content (e.g., news articles, emails, chat-rooms, etc.) having a variety of forms including text, images, video, audio, animation, program code, data structures, hyperlinks, etc. The base content is typically presented as a webpage and may be formatted according to the Hypertext Markup Language (HTML), the Extensible Markup Language (XML), Standard Generalized Markup Language (SGML), or any other language. As used herein, a primary webpage is requested by the user. Methods and apparatus described herein are used for selecting advertisements to serve to the user based on a referrer address of the primary webpage.

As used herein, additional content comprises one or more advertisements that are sent to the user that requests the primary webpage (base content) that are determined to be relevant to the primary webpage and/or of interest to the user. An advertisement may comprise or include a hyperlink (e.g., sponsored link, integrated link, inside link, or the like). An advertisement may include a similar variety of content and form as the base content described above.

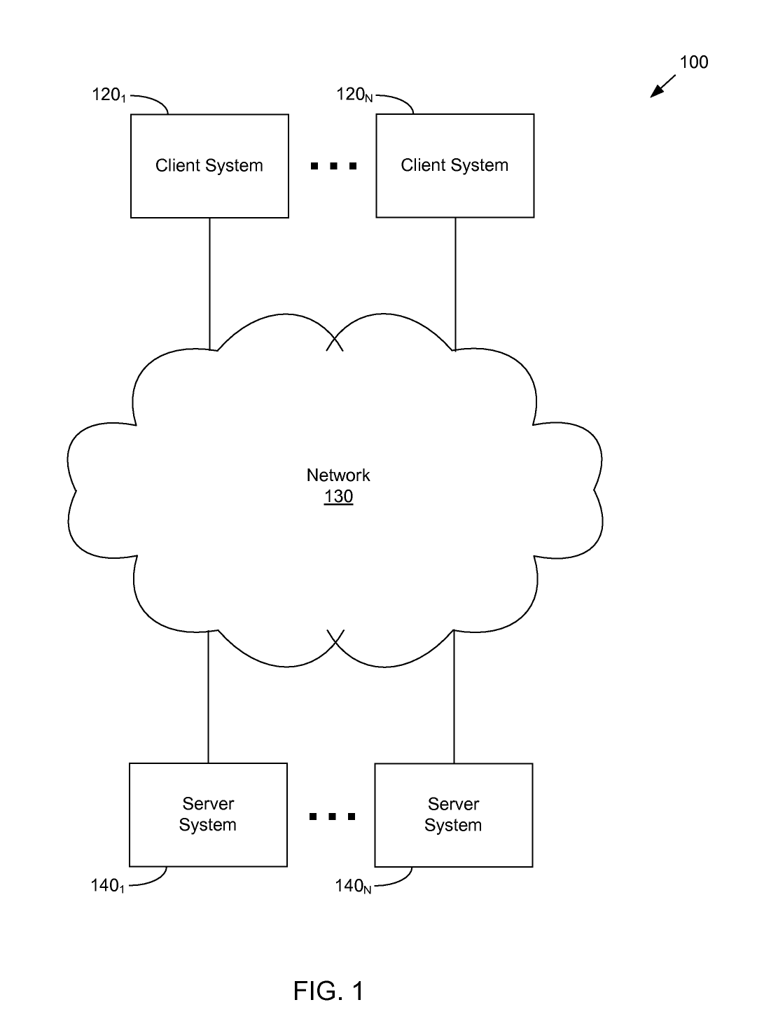

FIG. 1 shows a network environment 100 in which some embodiments operate. The network environment 100 includes, client systems 120₁ to 120_{N} and server systems 140₁ to 140_{N} coupled to a network 130 (such as the Internet or an intranet, an extranet, a virtual private network, a non-TCP/IP based network, any LAN or WAN, or the like). In some embodiments, the client system 120 and/or system servers 140₁ to 140_{N} are configured to perform the methods described herein. The methods of some embodiments may be implemented in software or hardware configured to optimize the selection of additional content to be displayed to a user.

A server system 140 may include, a single server computer or a plurality of server computers for providing a variety of network services (e.g., performing search queries, providing base content, and/or providing advertisements). Each client system 120 is configured to communicate with a server system 140. The client system 120 may include a desktop personal computer, workstation, laptop, PDA, cell phone, any wireless application protocol (WAP) enabled device, or any other device capable of communicating directly or indirectly to a network. The client system 120 typically runs a web browsing program (such as Microsoft's Internet Explorer™ browser, Netscape's Navigator™ browser, Mozilla™ browser, Opera™ browser, a WAP-enabled browser in the ease of a cell phone, PDA or other wireless device, or the like) allowing a user of the client system 120 to perform search queries and request and receive content from server systems 140₁ to 140_{N} over network 130. The client system 120 typically includes one or more user interface devices (such as a keyboard, a mouse, a roller ball a touch screen, a pen or the like) for interacting with, a graphical user interface (GUI) of the web browser on a display (e.g., monitor screen, LCD display, etc.).

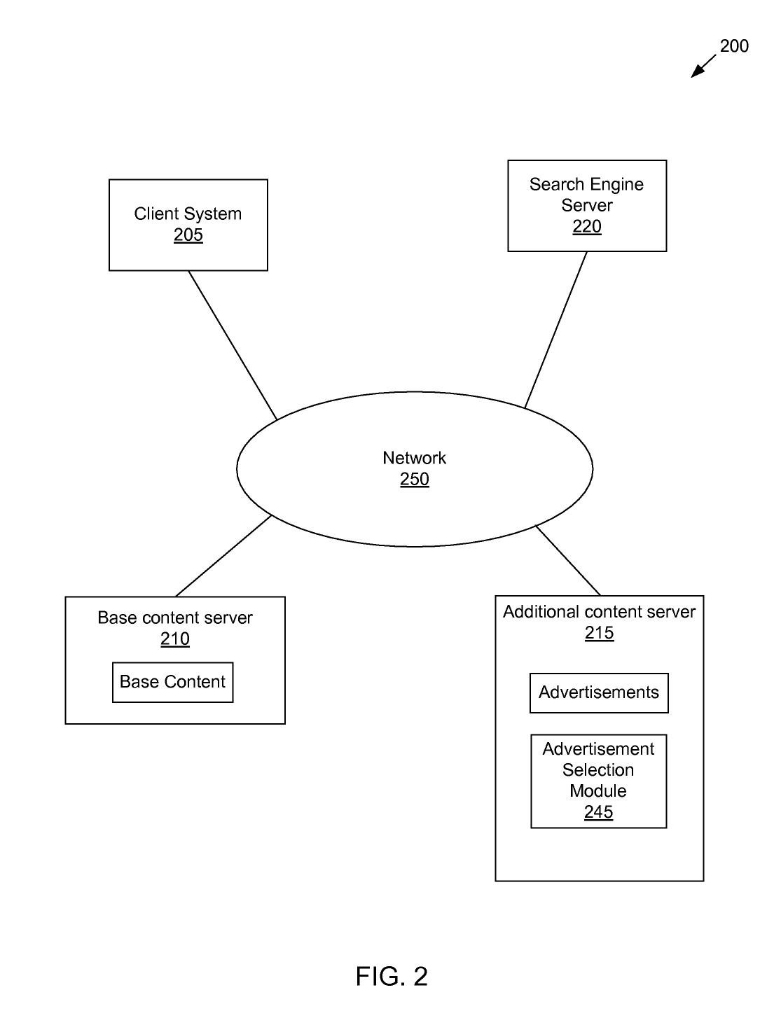

FIG. 2 shows a conceptual diagram of a revenue-optimization system 200. The revenue-optimization system 200 may include zero or more client system 205, zero or more base content servers (publishers) 210, zero or more additional content servers 215, or zero or more search engine servers 220, each connected to a network 250 (e.g., Internet). The revenue-optimization system 200 is configured to select additional content (advertisements) to be sent to a user/client system that maximizes expected revenue generation for base content providers, network service providers, and/or advertisers.

The client system 205 is configured to request and receive content (e.g., in the form of webpages) from a base content server 210 and/or additional content server 215, where such content may include base content (a requested webpage) and/or additional content (advertisements). In some embodiments, the client system 205 (operated by a user) may display an initial webpage (referred to as the referring webpage) that shows one or more hyperlinks to one or more landing webpages. Upon, selection of one of the hyperlinks (referred to as the primary hyperlink) by the user, the client system sends a request (e.g., HTTP request) to the base content server 210 that stores and maintains the selected landing webpage (the primary webpage) of the selected hyperlink. The request (for the primary webpage) sent to the base content server 210 includes a referrer of the primary webpage (e.g., an URL address of the prior referring webpage from which the primary webpage was retrieved).

The client system 205 may be further configured to request search queries and receive search results from the search engine server 220. In some embodiments, the client system 205 may display an initial query entry webpage where a user inputs (e.g., via a user interface) a search query (comprising one or more search query terms). The client system 205 then receives (from die search engine server 220) and displays a search results webpage (the referring webpage), the search results webpage having a URL address that contains terms of the search query. The search results webpage shows search results comprising one or more hyperlinks to one or more landing webpages. Upon selection of one of the hyperlinks (the primary hyperlink) by the user, the client system sends a request to the base content server 210 that stores and maintains the selected landing webpage (the primary webpage) of the selected hyperlink. The request (for the primary webpage) sent to the base content server 210 includes a referrer of the primary webpage (e.g., an URL address of the prior referring/search results webpage from which the primary webpage was retrieved).

After sending the request for the primary webpage to the base content server 210, the client system 205 may also be configured receive the primary webpage and additional content (advertisements) related to the primary webpage. The client system 205 is further configured to display the received base content and/or additional content to a user and receive selections of advertisements from the user (e.g., through a user interface).

The search engine server 220 is configured to receive a search query from the client system 205, perform the search query (comprising one or more terms), attach the search query terms to the uniform resource locator (URL) address of a search results webpage, and serve the search results webpage to the client system 205, the search results webpage typically comprising search results in the form of one or more hyperlinks to one or more landing webpages.

The base content server (publisher) 210 stores a plurality of webpages (base content) and is configured to receive requests (e.g., HTTP requests) for webpages and retrieve and send requested webpages. The additional content server 215 stores a plurality of advertisements (additional content) from various advertisers. In some embodiments, an advertisement is associated with one or more keywords that represent and describe the advertisement. In other embodiments, an advertisement is associated with one or more bidded phrases, a bidded phrase comprising one or more keywords/terms. The additional content server 215 comprises an advertisement selection module 245 that is used to determine which advertisements from the additional content server 215 to serve to the user/client system requesting the primary webpage.

In some embodiments, the advertisement selection module 245 receives a referrer of a primary webpage (or receives terms extracted from the referrer of the primary webpage), where the referrer may comprise an URL address of a prior referring webpage from which the primary webpage was retrieved. In some embodiments, the referrer of the primary webpage comprises one or more search query terms from a user requesting the primary webpage. The advertisement, selection module 245 uses the referrer (or terms extracted from the referrer) to determine one or more advertisements to serve to the user/client system 205 requesting the primary webpage. In further embodiments, the advertisement selection module 245 may also use content data of the primary webpage in selecting the one or more advertisements to serve.

In determining which advertisements to serve to the user/client system 205, the advertisement selection module 245 may use the referrer and/or content information to determine a list of one or more primary webpage keywords (indicating copies/subject areas) that are related to the primary webpage or that may be of interest to the user. In some embodiments, the advertisement selection module 245 selects for serving those advertisements in the additional content server 215 having an associated keyword that matches one or more of the primary webpage keywords. As used herein, a keyword can comprise a single term (e.g., “cats,” “television,” etc.) or a plurality of terms (e.g., “car dealer,” “New York City,” etc.). For example, the set of primary webpage keywords may comprise “automobile,” “sports car,” “sports car accessories,” etc. A particular advertisement may be represented by the keywords “sports car,” “high performance automobile,” etc. Since the advertisement keyword “sports ear” matches the primary webpage keyword “sports ear” (i.e., “sports car” represents the advertisement as well as the primary webpage), this particular advertisements may be selected for serving to the user.

The additional content server 215 may be part of a network service provider (such as Yahoo! and its associated properties) that provide users an entrance and guide into the resources of the Internet. The network service provider may include one or more search engine servers 220, one or more base content servers 210, and/or one or more additional content servers 215 to provide a range of search, email, news, shopping, and other content and services. In other embodiments, the base content server 210, the additional content server 215, and/or search engine server 220 may be operated by separate entities.

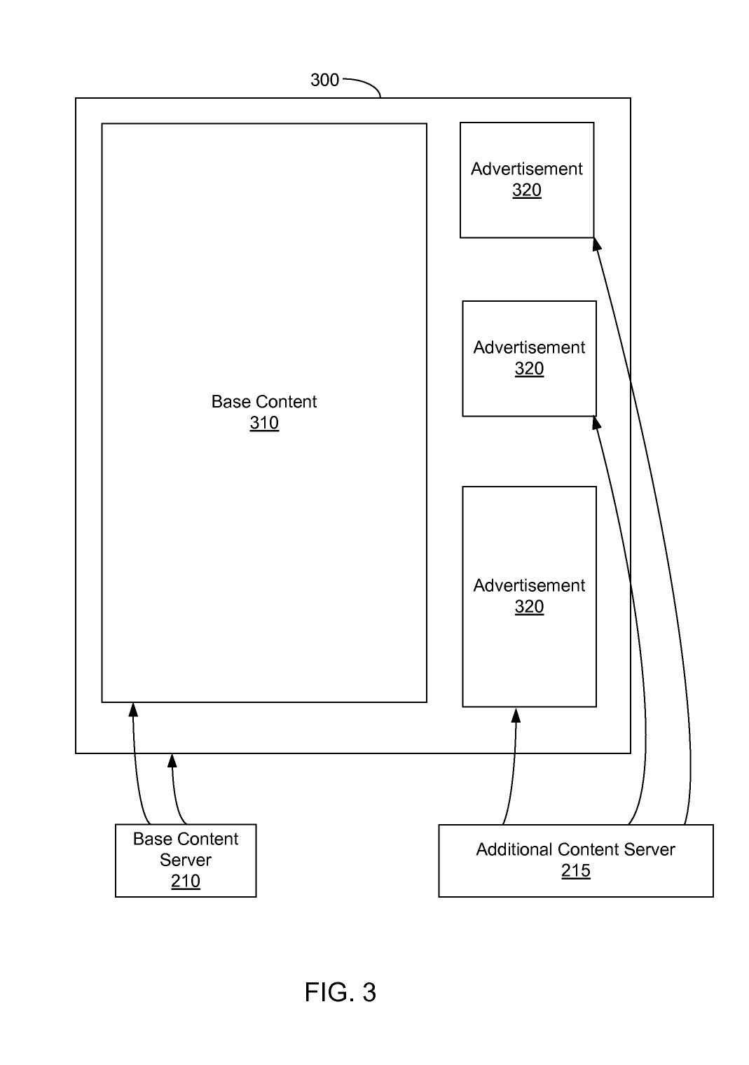

FIG. 3 is a block diagram of an exemplary interface 300 for displaying base content and additional content according to some embodiments. The interface 300 may be implemented and displayed by the client system 205 (e.g., via a web browsing program). The interface may comprise a webpage 300, such as a primary webpage requested by a user, received from a base content server 210. The webpage may incorporate base content 310 received from a base content server 210 and/or additional content (advertisements) 320 received from an additional content server 215. The base content may include, for example, articles, and/or other information of interest to users, often displayed in a variety of formats, such as text, video, audio, hyperlinks, or other formats.

In some embodiments, the webpage 300 also includes data regarding the referrer of the webpage 300 (e.g., a URL address of the prior referring webpage from which the webpage 300 was retrieved), for example, attached to the metadata field of the webpage 300). The primary webpage may further include an embedded advertisement request mechanism (e.g., iframe, mechanism, JavaScript code, etc.) configured to make an advertisement request (e.g., HTTP request) to an additional content, server 215 to send one or more advertisements to serve with the primary webpage. In some embodiments, the embedded advertisement request mechanism is configured to read the data regarding the referrer of the webpage 300 (e.g., read the referrer data from the metadata field of the webpage 300) and include the referrer data in the advertisement request to the additional content server. In other embodiments, the embedded advertisement request mechanism is configured to extract one or more terms from the referrer data and include the one or more extracted terms in the advertisement request to the additional content server. The advertisement request mechanism embedded in the webpage 300 may be configured to perform these operations, for example, upon the webpage 300 being received and displayed by the client system. As advertisements are received, they may be displayed with the webpage 300. In some embodiments, the received advertisements are included and displayed within the webpage 300 as additional content 320.

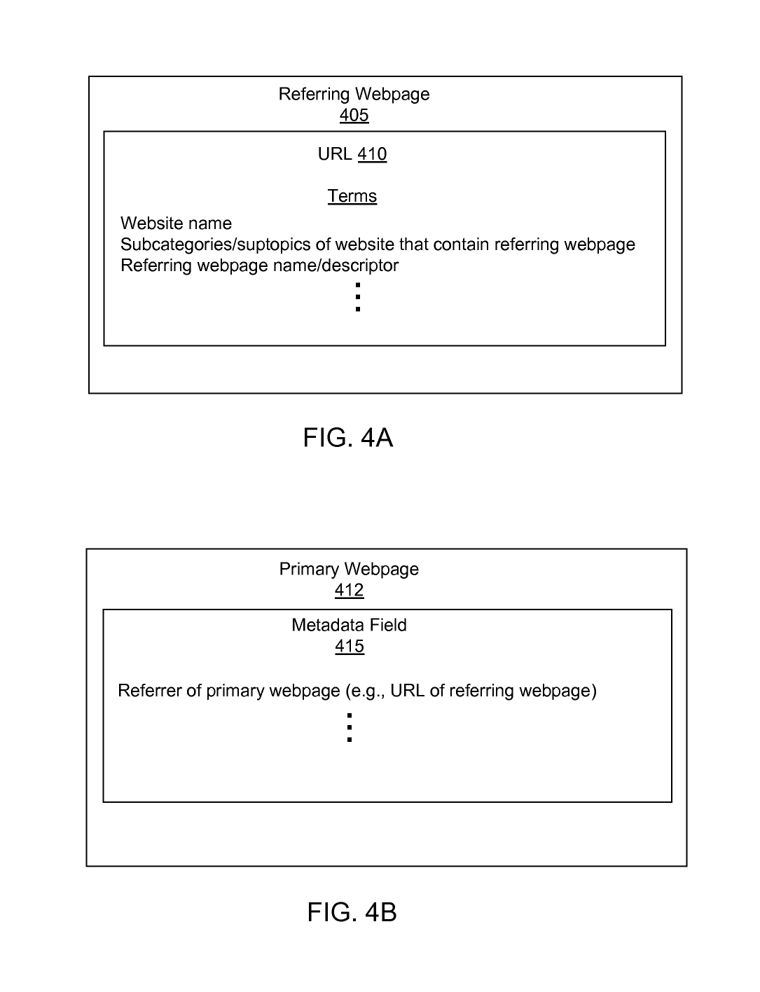

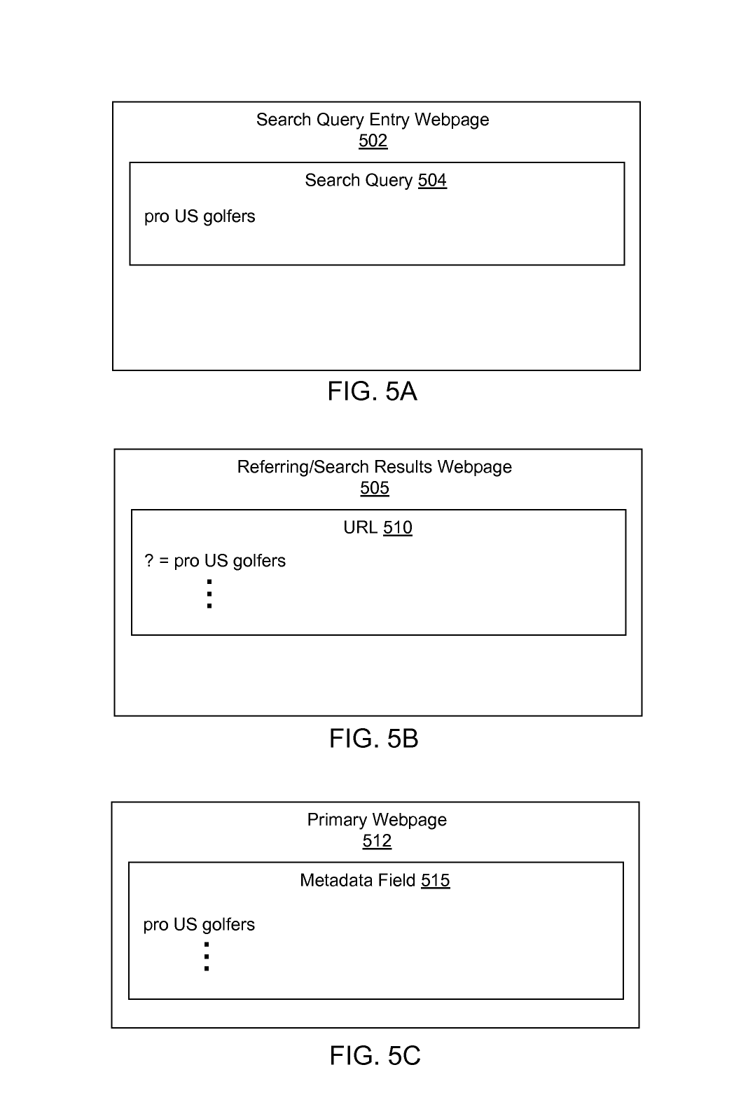

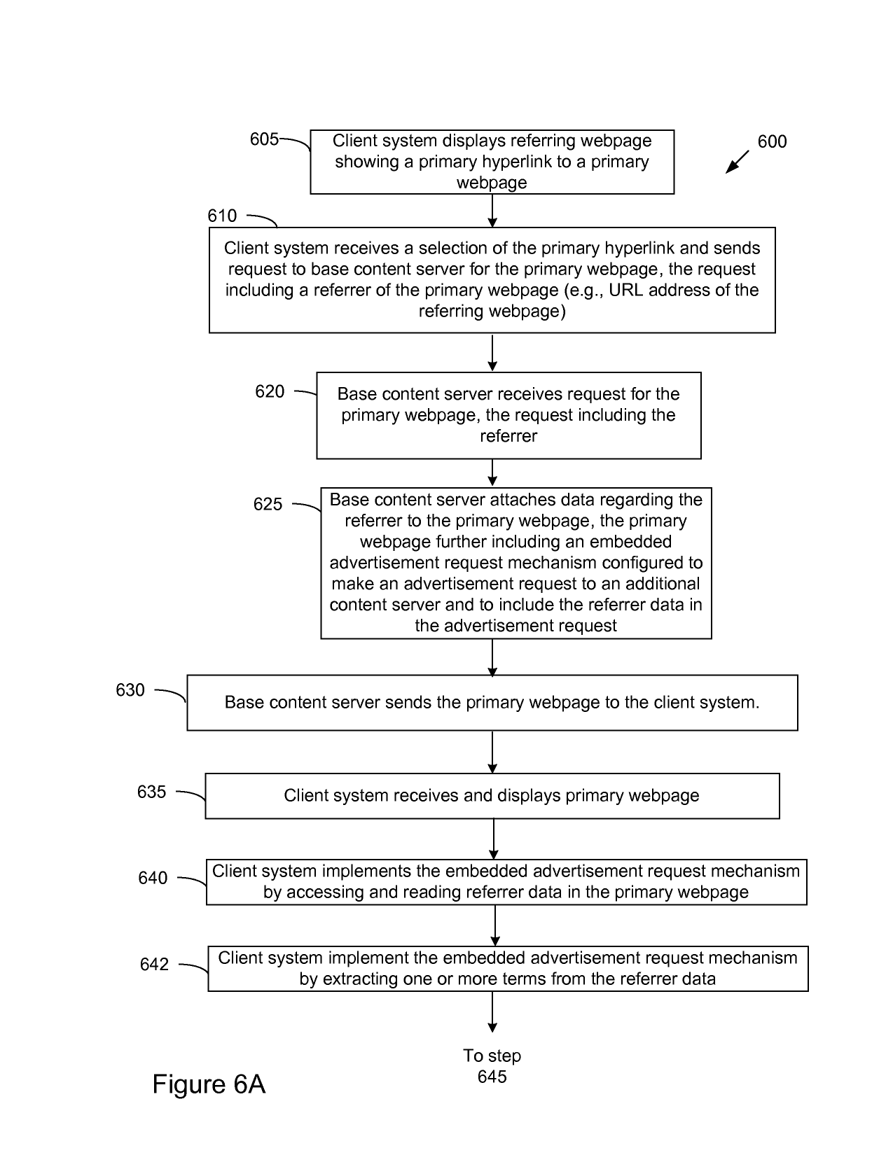

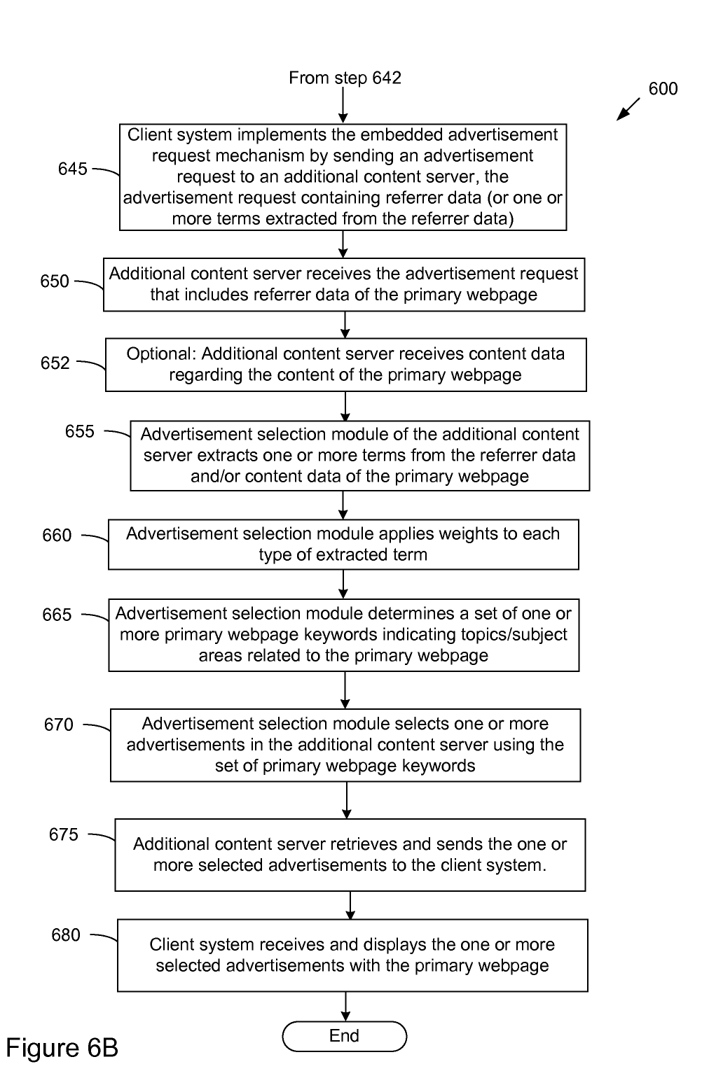

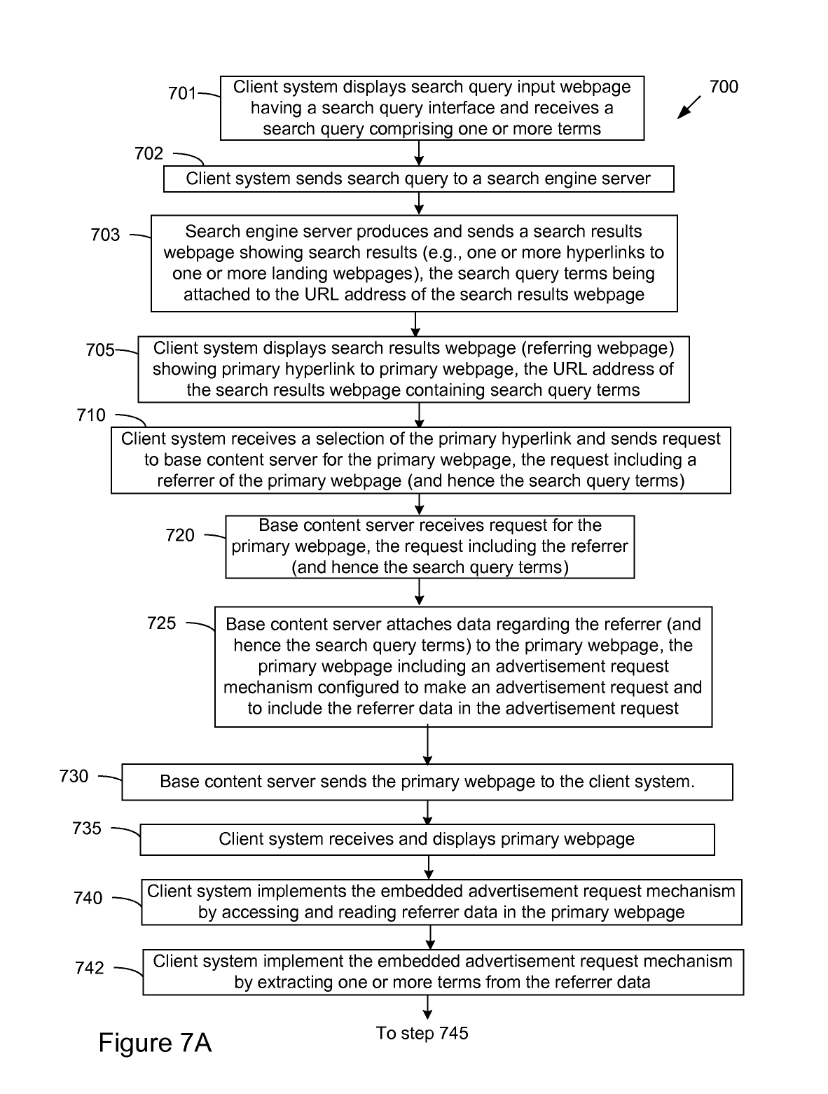

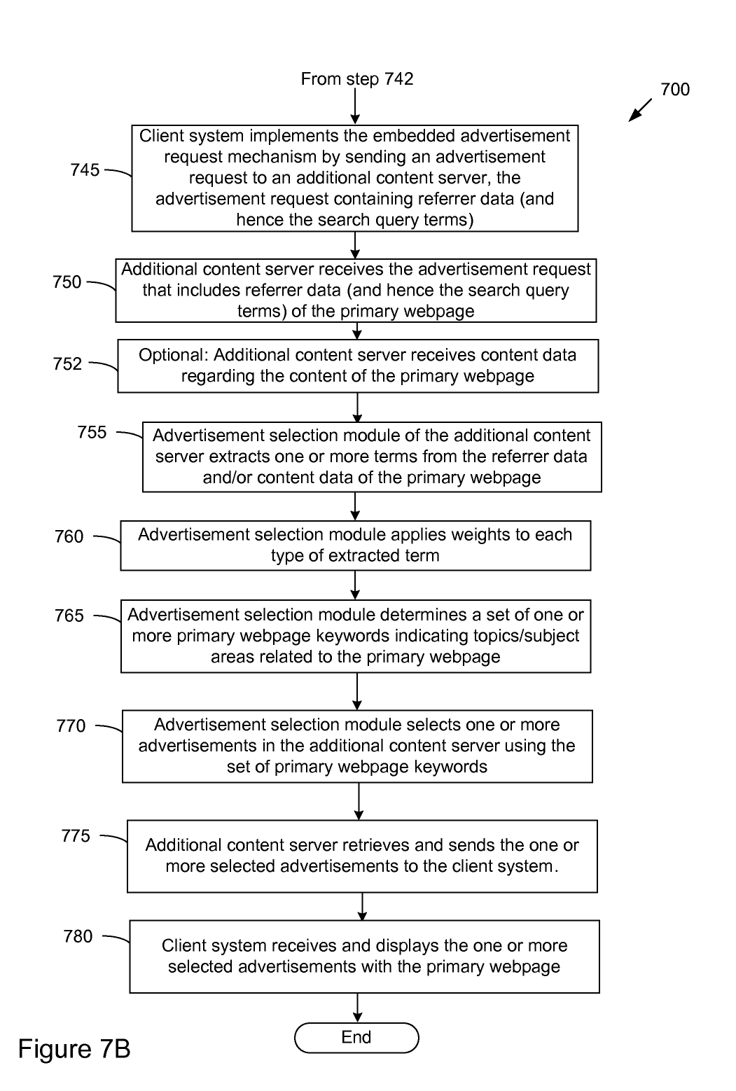

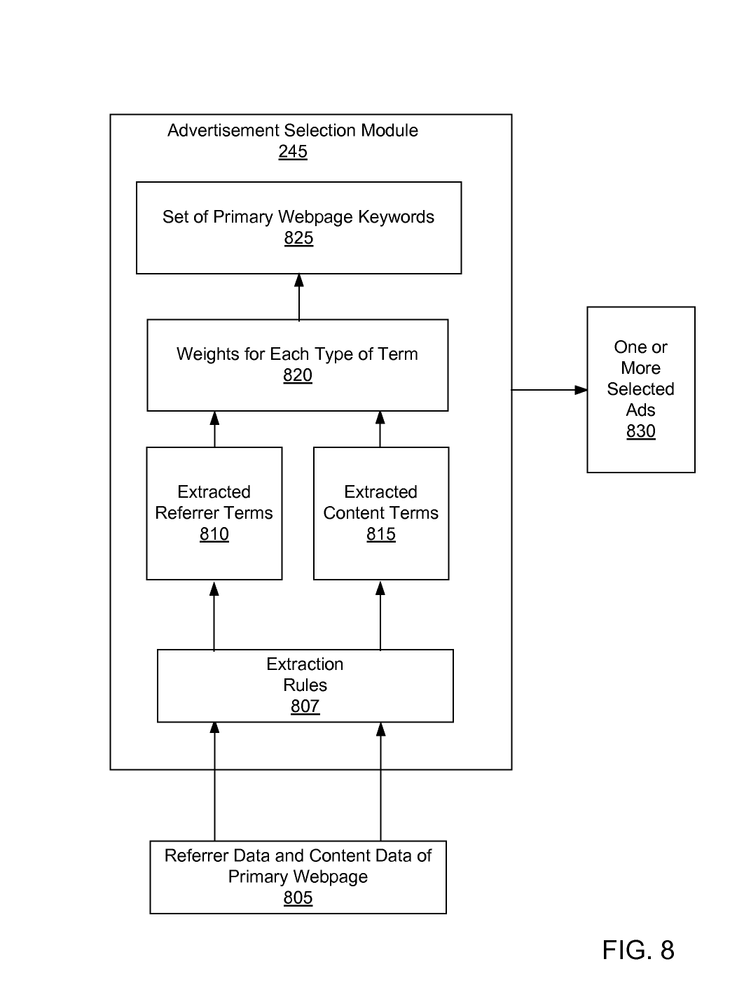

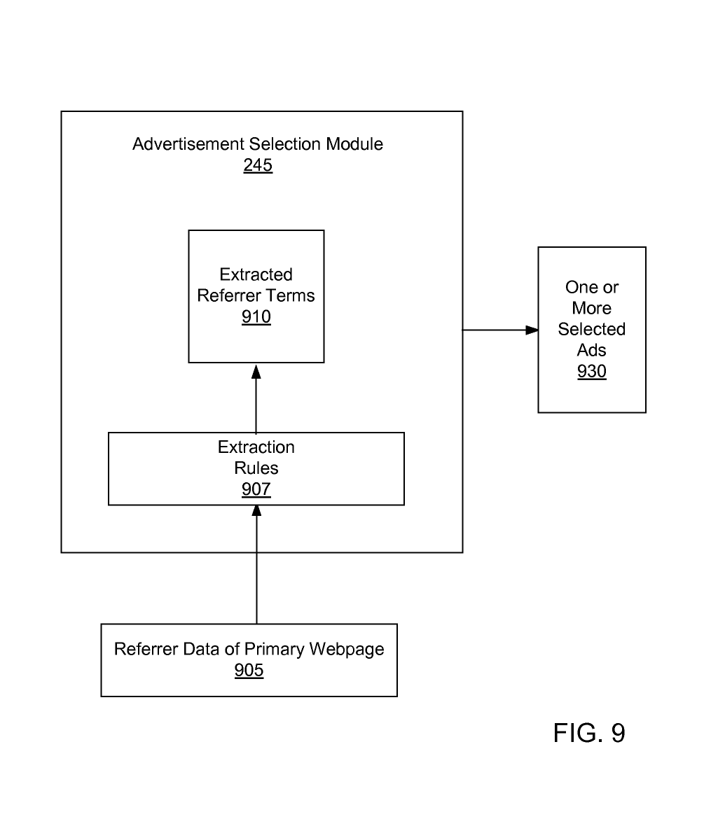

FIG. 4A shows an exemplary referring webpage 405 having a URL address 410. The URL address 410 of the referring webpage 405 typically contains one or more terms that describe or are related to the referring webpage 405. Such terms may include, for example, website name (e.g., www.generichardwarestore.com), subcategories/subtopics of the website that contain the referring webpage (e.g., outdoor/lawn/tools), referring webpage name/descriptor (e.g., shovels), etc. In other embodiments, the URL address 410 of the referring webpage 405 include other types of terms that describe or are related to the referring webpage 405.

FIG. 4B shows an exemplary primary webpage 412 having a metadata section 415. The primary webpage 412 is stored and maintained by a base content server that receives and responds to requests for the primary webpage 412 from client systems. A request for the primary webpage 412 typically contains a referrer of the primary webpage (e.g., URL address of the prior referring webpage from which the primary webpage 412 was retrieved). In some embodiments, the base content server writes the referrer to the metadata section 415 of the primary webpage 412 prior to sending the primary webpage 412 to the client system.

In some embodiments, a user/client system may submit a search query to a search engine server. FIG. 5A shows an exemplary search query entry webpage 502 having a search query interface 504 for receiving, from a user, a search query comprising one or more terms (e.g., “pro US golfer”). The search query is sent to a search engine server that, in response, returns a search results webpage (the referring webpage) showing search results (e.g., in the form of one or more hyperlinks to one or more landing webpages). When creating the search results webpage, the search engine server typically attaches the received search query terms to the URL address of the search results webpage (referring webpage). FIG. 5B shows an exemplary search results/referring webpage 505 having a URL address 510 containing attached search query terms (e.g., “pro US golfer”).

The search query may be attached to the URL of the search results webpage 505, for example, as attribute-value pairs. Currently, several different attribute names are used to indicate a search query in the URL of a webpage. FIG. 5B shows an example of an attribute name “?” used for indicating a search query in the URL of a webpage. Various examples of attribute-value pairs include:

attribute name—search query value

“?” “pro US golfers”

“tag” “pro US golfers”

“search” “pro US golfers”

“C” “pro US golfers”

FIG. 5C shows an exemplary primary webpage 512 having a metadata section 515. The primary webpage 512 is stored and maintained by a base content server that receives and responds to requests for the primary webpage 512 from client systems. A request for the primary webpage 512 typically contains a URL address (and hence search query terms) of the prior search results/referring webpage from which the primary webpage 512 was retrieved. In some embodiments, the base content server writes the URL address 510 of the referring webpage 505 (and hence writes the search query terms) to the metadata section 515 of the primary webpage 512 prior to sending the primary webpage 512 to the client system.

Section II: Selecting Advertisements to Serve with a Webpage Based on a Referrer of the Webpage

FIGS. 6A-8 are flowcharts of a method 600 for selecting one or more advertisements to serve to a user/client system requesting a webpage. In some embodiments, the method 600 is implemented by software or hardware configured to select the advertisements. In some embodiments, the steps of method 600 are performed using one or more servers (such as base content server 210 and additional content server 215), one or more modules (such as advertisement selection module 245), and/or one or more client systems (such as client system 205). The order and number of steps of the method 600 are for illustrative purposes only and, in other embodiments, a different order and/or number of steps are used.

The method 600 begins when the client system displays (at 605) an initial webpage (the referring webpage) that shows one or more hyperlinks to one or more landing webpages. The client system then receives (at 610) a selection of one of the hyperlinks (the primary hyperlink) by a user and sends a request to a base content server that stores and maintains the selected landing webpage (the primary webpage) of the selected hyperlink. The client system (e.g., via the web browser program) includes a referrer of the primary webpage (e.g., a URL address of the prior referring webpage from which the primary webpage was retrieved) in the request for the primary webpage.

The base content server receives (at 620) the request for the primary webpage (the request including the referrer of the primary webpage). The base content server then attaches (at 625) data regarding the referrer to the primary webpage (e.g., attached to the metadata field of the primary webpage). The primary webpage further includes an embedded advertisement request mechanism configured to make an advertisement request to an additional content server to send one or more advertisements to serve with the primary webpage. In some embodiments, the embedded advertisement request mechanism may be further configured to read data regarding the referrer of the primary webpage (e.g., read the referrer data from the metadata field of the primary webpage) and include the referrer data in the advertisement request to the additional content server. The base content server sends (at 630) the primary webpage to the client system.

The client system receives and displays (at 635) the primary webpage from the base content server. Upon doing so, the client system implements the embedded advertisement request mechanism by accessing and reading (at 640) referrer data in the primary webpage. In some embodiments, the client system may implement the advertisement request mechanism by extracting (at 642) one or more terms from the referrer data in the primary webpage. The client system further implements the embedded advertisement request mechanism by sending (at 645) an advertisement request to an additional content server to send one or more advertisements to serve with the primary webpage, wherein the advertisement request contains referrer data (or one or more terms extracted from the referrer data). The additional content server receives (at 650) the advertisement request (that includes referrer data of the primary webpage and/or terms extracted from the referrer data).

As an optional step, content data regarding the content of the primary webpage is received (at 652) by the additional content server 215 as well. The content data comprises data of the content of primary webpage which may comprise items such as text (e.g., news articles, movie reviews, etc.), graphics, images, animation, video, audio, etc. that are presented in the primary webpage. Primary webpage content also typically includes one or more hyperlinks to one or more landing webpages. The content data of the primary webpage may be sent to the additional content server 215 using a variety of methods known in the art. For example, the content data may be included in the advertisement request sent by the advertisement request mechanism to the additional content server 215. As a further example, the advertisement request sent to the additional content server 215 may include the URL of primary webpage wherein the additional content server 215 then issues an HTTP request to the base content server 210 to receive the content data of primary webpage.

The advertisement selection module 245 of the additional content server then extracts (at 655) one or more terms from the referrer data and, optionally, also extracts one or more terms from the content data of the primary webpage (using, for example, a set of extraction rules). The advertisement selection module then applies (at 660) weights to each type of extracted terms, such as different weights for terms extracted from the referrer data and terms extracted from the primary webpage content data. Using the extracted terms and their respective weights, the advertisement selection module then determines (at 665) a set of one or more primary webpage keywords indicating topics/subject areas that are related to the primary webpage or that may be of interest to the user. In some embodiments, only the terms extracted from the referrer data is considered whereby the set of primary webpage keywords comprises the extracted terms themselves.

The advertisement selection module then selects (at 670) one or more advertisements in the additional content server using the set of primary webpage keywords (e.g., by matching or comparing primary webpage keywords with keywords associated with the advertisements). The additional content server then retrieves and sends (at 675) the one or more selected advertisements to the client system. The client system receives and displays (at 680) the one or more selected advertisements with the primary webpage. The method 600 then ends.

As discussed above, the method 600 uses (in steps 655 to 670) data regarding the referrer of a primary webpage (e.g., an URL address of the prior referring webpage from which the primary webpage was retrieved) to select one or more advertisements to serve with the primary webpage.

FIGS. 7A-B are flowcharts of a method 700 for selecting one or more advertisements to serve to a user/client system performing a search query and requesting a webpage. In some embodiments, the method 700 is implemented by software or hardware configured to select the advertisements. In some embodiments, the steps of method 700 are performed using one or more servers (such as search engine server 220, base content server 210, and additional content server 215), one or more modules (such as advertisement selection module 245), and/or one or more client systems (such as client system 205). The order and number of steps of the method 700 are for illustrative purposes only and, in other embodiments, a different order and/or number of steps are used. Some of the steps of the method 700 are similar to the steps of the method 700 of FIG. 7 and only those steps that differ are discussed in detail here.

The method 700 begins when the client system displays (at 701) an initial webpage (the search query input webpage) having a search query interface and receives a search query (comprising one or more terms) from a user. The client system sends (at 702) the search query to a search engine server 220 that performs a search over a network (e.g., Internet) for webpages based on the search query to produce a set of search results. The search engine server 220 produces and sends (at 703) a search results webpage showing search results (e.g., as one or more hyperlinks to one or more landing webpages), wherein the search engine server 220 attaches the search query to the URL address of the search results webpage.

The client system then receives and displays (at 705) the search results webpage (the referring webpage) that shows one or more hyperlinks to one or more landing webpages, the URL address of the search results webpage containing search query terms. The client system then receives (at 710) a selection of one of the hyperlinks (the primary hyperlink) and sends a request to a base content server that stores and maintains the selected landing webpage (the primary webpage) of the selected hyperlink. The client system includes a referrer of the primary webpage (and hence the search query terms) in the request for the primary webpage.

The base content server receives (at 720) the request for the primary webpage (the request including the referrer of the primary webpage and hence the search query terms). The base content server then attaches (at 725) data regarding the referrer to the primary webpage (and hence attaches data regarding the search query terms to the primary webpage). The primary webpage further includes an embedded advertisement request mechanism. The base content server sends (at 730) the primary webpage to the client system.

The client system receives and displays (at 735) the primary webpage from the base content server. Upon doing so, the client system implements the embedded advertisement request mechanism by accessing and reading (at 740) referrer data in the primary webpage, extracting (at 742) one or more terms from the referrer data in the primary webpage, and sending (at 745) an advertisement request to an additional content server, wherein the advertisement request contains referrer data (and hence contains search query terms). The additional content server receives (at 750) the advertisement request (that includes referrer data of the primary webpage and hence search query terms). As an optional step, content data of the primary webpage is received (at 752) by the additional content server 215 as well.

The advertisement selection module 245 of the additional content server then extracts (at 755) one or more terms from the referrer data (containing search query terms) and, optionally, also extracts one or more terms from the content data of the primary webpage. The advertisement selection module then applies (at 760) weights to each type of extracted term. Using the extracted terms and their respective weights, the advertisement selection module then determines (at 765) a set of one or more primary webpage keywords related to the primary webpage. In some embodiments, only the terms extracted from the referrer data (containing search query terms) is considered whereby the set of primary webpage keywords comprises the extracted terms themselves. The advertisement selection module then selects (at 770) one or more advertisements in the additional content server using the set of primary webpage keywords. The additional content server then retrieves and sends (at 775) the one or more selected advertisements to the client system. The client system receives and displays (at 780) the one or more selected advertisements with the primary webpage. The method 700 then ends. As discussed above, the method 700 uses (in steps 755 to 770) data regarding the referrer of a primary webpage (the referrer containing search query terms) to select one or more advertisements to serve with the primary webpage.

FIG. 8 shows a conceptual diagram of the operation of the advertisement selection module 245 of the additional content server 215 in selecting advertisements to serve to a client system that requests a primary webpage. The advertisement selection module 245 may be implemented in software or hardware configured to perform the functions described below.

As shown in FIG. 8, the advertisement selection module 245 receives input 805 comprising referrer data and content data of the requested primary webpage. Content data includes data regarding content displayed on the primary webpage (e.g., hyperlinks, text, graphics, images, animation, video, audio, etc.). As discussed above, referrer data is data regarding the referrer of the primary webpage (which may or may not contain search query terms). The advertisement selection module 245 then applies a set of extraction rules 807 to extract terms from the content and referrer data 805. In some embodiments, the set of extraction rules 807 defines a list of attribute names indicating search query terms to be detected in the received referrer data. For example, the set of extraction rules 807 may include commonly used attribute names used to indicate a search query value in the URL of the webpage (e.g., “?,” “tag,” “search,” etc.). The advertisement selection module 245 searches the received data for attribute names listed in the set of extraction rules 807 to locate and extract search query values (comprising one or more terms).

Using the set of extraction rules 807, the advertisement selection module 245 extracts terms 810 from the referrer data (referrer terms) and terms 815 from the content data (content terms). The advertisement selection module 245 may apply weights 820 to each type of extracted term that reflects the degree of influence the type of term has on the selection of the advertisements. For example, the referrer terms 810 may be weighted higher than the content terms 815 so that the referrer terms 810 have a greater effect on the selection of the advertisements.

From the extracted terms 810 and 815, the advertisement selection module 245 determines a set of one or more primary webpage keywords 825 indicating topics/subject areas that are related to the requested primary webpage or that may be of interest to the user. Different methods for determining keywords from content terms may be used. Methods for determining keywords from content terms are well known in the art and not discussed in detail here. In some embodiments, the referrer terms 810 are considered along with the content terms 815 in determining the set of primary webpage keywords. In other embodiments, only the referrer terms 810 are considered in determining the set of primary webpage keywords.

The advertisement selection module 245 then selects advertisements in the additional content server 215 based on the set of primary webpage keywords. For example, the advertisement selection module 245 may select those advertisements in the additional content server 215 having an associated keyword that matches one or more of the primary webpage keywords. The one or more selected advertisements 830 are then served to the client system that requested the primary webpage.

FIG. 9 shows a conceptual diagram of an alternative embodiment of the advertisement selection module 245 in selecting advertisements to serve to a client system that requests a primary webpage. In the embodiment of FIG. 9, only the terms extracted from the referrer data that comprise search query terms is considered in selecting advertisements in a “bidded phrase” setting.

As shown in FIG. 9, the advertisement selection module 245 receives as input referrer data 905 of the primary webpage, the referrer data comprising search query terms submitted by the client system. The advertisement selection module 245 then applies a set of extraction rules 907 (e.g., comprising a list of attribute names indicating search query terms) to extract search query terms 910 from the referrer data 905. The advertisement selection module 245 may then select an advertisement in the additional content server 215 having an associated keywords/terms (i.e., bidded phrase) that matches the search query terms 910. The one or more selected advertisements 930 are then served to the client system that requested the primary webpage.

While the Invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A system for selecting one or more advertisements to serve to a client system requesting a primary webpage, the system comprising:
an advertisement selection module configured for:
receiving referrer data of the primary webpage, the referrer data comprising a uniform resource locator (URL) address of a referring webpage containing a primary hyperlink to the primary webpage, wherein the client system requests the primary webpage by selecting the primary hyperlink in the referring webpage; and
using the referrer data of the primary webpage to select the one or more advertisements to serve to the client system.

2. The system of claim 1, wherein:
the advertisement selection module is further configured for extracting one or more terms from the referrer data of the primary webpage; and
the advertisement selection module is configured for using the referrer data of the primary webpage to select the one or more advertisements by using the one or more terms extracted from the referrer data to select the one or more advertisements.

3. The system of claim 1, wherein the referrer date comprises one or more terms extracted from the URL address of the referring webpage.

4. The system of claim 1, further comprising:
a base content server configured for:
storing a plurality of webpages;
receiving a webpage request for the primary webpage from the client device, the webpage request comprising the referrer data of the primary webpage; and
retrieving and sending the primary webpage to the client device, wherein the primary webpage comprises the referrer data.

5. The system, of claim 1, further comprising:
an advertisement server configured for:
storing a plurality of advertisements;
receiving an advertisement request from the client system, wherein the advertisement request comprises the referrer data of the primary webpage;
implementing the advertisement selection module for selecting one or more advertisements to serve to the client system using the referrer data of the primary webpage; and
retrieving and sending the one or more selected advertisements to the client system.

6. The system of claim 5, wherein the client system implements an advertisement request mechanism embedded in the primary webpage, the advertisement request mechanism configured for submitting an advertisement request to the advertisement server when the primary webpage is displayed on the client system and attaching the referrer data of the primary webpage to the advertisement request.

7. The system of claim 6, wherein the advertisement request mechanism is further configured for extracting one or more terms from the URL address of the referring webpage, the referrer data comprising the one or more extracted terms.

8. The system of claim 1, wherein;
the referrer data comprises one or more search query terms submitted by the client system.

9. The system of claim 8, further comprising a search engine server configured for:
receiving the one or more search query terms from the client system;
producing the referring webpage comprising search results of the search query terms, the search results comprising the primary hyperlink, to the primary webpage;
attaching the search query terms to the URL address of the referring webpage; and
sending the referring webpage to the client system.

10. The system of claim 8, wherein:
each of a plurality of advertisements has an associated bidded phrase comprising one or more keywords; and
the advertisement selection module is configured for using the referrer data of the primary webpage to select the one or more advertisements by matching the search query terms of the referrer data to a bidded phrase of a particular advertisement and selecting the particular advertisement to serve to the client system.

11. The system of claim 1, wherein the advertisement selection module is further configured for:
receiving content data of the primary webpage; and
using the referrer data and content data to select the one or more advertisements.

12. The system of claim 11, wherein:
the referrer data is weighted higher than the content data of the primary webpage to have a greater effect on the selection of the one or more advertisements.

13. A computer-implemented method for selecting one or more advertisements to serve to a client system requesting a primary webpage, the method comprising:
receiving referrer data of the primary webpage, the referrer data comprising a uniform resource locator (URL) address of a referring webpage containing a primary hyperlink to the primary webpage, wherein the client system requests the primary webpage by selecting the primary hyperlink in the referring webpage; and
using the referrer data of the primary webpage to select the one or more advertisements to serve to the client system.

14. The method of claim 13, further comprising extracting one or more terms from the referrer data of the primary webpage, wherein using the referrer data of the primary webpage to select the one or more advertisements comprises using the one or more terms extracted from the referrer data to select the one or more advertisements.

15. The method of claim 13, wherein:
the referrer data comprises one or more search query terms submitted by the client system.

16. The method of claim 15, wherein:
each of a plurality of advertisements has an associated bidded phrase comprising one or more keywords; and
using the referrer data of the primary webpage to select the one or more advertisements comprises matching the search query terms of the referrer data to a bidded phrase of a particular advertisement and selecting the particular advertisement to serve to the client system.

17. The method of claim 13, further comprising:
receiving content data of the primary webpage; and
using the referrer data and content data to select the one or more advertisements.

18. A computer program product comprising a computer readable medium having instructions stored thereon when executed, select one or more advertisements to serve to a client system requesting a primary webpage, the computer program product comprising sets of instructions for:
receiving referrer data of the primary webpage, the referrer data comprising a uniform resource locator (URL) address of a referring webpage containing a primary hyperlink to the primary webpage, wherein the client system requests the primary webpage by selecting the primary hyperlink in the referring webpage; and
using the referrer data of the primary webpage to select the one or more advertisements to serve to the client system.

19. The computer program product of claim 18, further comprising a set of instructions for extracting one or more terms from the referrer data of the primary webpage, wherein the set of instructions for using the referrer data of the primary webpage to select the one or more advertisements comprises a set of instructions for using the one or more terms extracted from the referrer data to select the one or more advertisements.

20. The computer program product of claim 18, wherein:
the referrer data comprises one or more search query terms submitted by the client system.

21. The computer program product of claim 20, wherein:
each of a plurality of advertisements has an associated bidded phrase comprising one or more keywords; and
the set of instructions for using the referrer data of the primary webpage to select the one or more advertisements comprises a set of instructions for matching the search query terms of the referrer data to a bidded phrase of a particular advertisement and selecting the particular advertisement to serve to the client system.

22. The computer program product of claim 18, further comprising sets of instructions for:
receiving content data of the primary webpage; and
using the referrer data and content data to select the one or more advertisements.
